(19) United States
(12) Patent Application Publication
(10) Pub. No.: US 2019/0289146 A1
(43) Pub. Date: Sep. 19, 2019

(54) INFORMATION PROCESSING APPARATUS, INFORMATION PROCESSING METHOD AND NON-TRANSITORY COMPUTER-READABLE STORAGE MEDIUM

(71) Applicant: Hiroto KOBAYASHI, Brentford (GB)

(72) Inventor: Hiroto KOBAYASHI, Brentford (GB)

(21) Appl. No.: 16/299,205

(22) Filed: Mar. 12, 2019

(30) Foreign Application Priority Data
Mar. 19, 2018 (JP) 2018-050881

(51) Int. Cl. H04N 1/00; G06F 3/12

(52) U.S. Cl. CPC H04N 1/00464; H04N 1/00411; G06F 3/1208; G06F 3/1254; G06F 3/1255; G06F 3/1204

(57) ABSTRACT

An information processing apparatus receives information relating to an operation of an image forming device from another information processing apparatus connected to the information processing apparatus via a communication line and displays the information received from the another information processing apparatus. The information processing apparatus includes circuitry. The circuitry is configured to cause a display to display a setting screen via which a setting relating to image formation is accepted. The circuitry is configured to, in response to accepting a request operation by a user, transmit request information based on setting information accepted via the setting screen to the another information processing apparatus. The circuitry is configured to cause a browser to receive the information relating to the operation corresponding to the request information from the another information processing apparatus and display the received information relating to the operation.

### CROSS-REFERENCE TO RELATED APPLICATION

This patent application is based on and claims priority pursuant to 35 U.S.C. § 119(a) to Japanese Patent Application No. 2018-050881, filed on Mar. 19, 2018, in the Japan Patent Office, the entire disclosure of which is hereby incorporated by reference herein.

### BACKGROUND

### Technical Field

The present disclosure relates to an information processing apparatus, an information processing method, and a non-transitory computer-readable storage medium.

### Description of the Related Art

In an image forming device such as a printer, a function of the image forming device can be set by using a user interface of a printer driver installed in a computer apparatus.

There are many functions that cannot be set because the image forming device has many exclusive relationships between a state and a function of the device and among the functions. In the image forming device, a prohibition is provided in order to reduce inconveniences that functions having contradictory content are set.

### SUMMARY

According to an embodiment of the present disclosure, an information processing apparatus receives information relating to an operation of an image forming device from another information processing apparatus connected to the information processing apparatus via a communication line and displays the information received from the another information processing apparatus. The information processing apparatus includes circuitry. The circuitry is configured to cause a display to display a setting screen via which a setting relating to image formation is accepted. The circuitry is configured to, in response to accepting a request operation by a user, transmit request information based on setting information accepted via the setting screen to the another information processing apparatus. The circuitry is configured to cause a browser to receive the information relating to the operation corresponding to the request information from the another information processing apparatus and display the received information relating to the operation.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is an overall configuration diagram of a printing system according to an embodiment of the present disclosure;

FIG. 2 is a hardware configuration diagram of a computer apparatus included in the printing system according to an embodiment of the present disclosure;

FIG. 3 is a functional block diagram of a computer apparatus according to an embodiment of the present disclosure;

FIG. 4 is a diagram illustrating a display example of a setting user interface (UI) used for print setting, according to an embodiment of the present disclosure;

FIG. 5 is a conceptual diagram illustrating an example of a state, a setting function, and a function to be changed of a printer, according to an embodiment of the present disclosure;

FIG. 6A is a diagram illustrating a display example of a balloon help whose display amount is less than a threshold value, according to an embodiment of the present disclosure;

FIG. 6B is a diagram illustrating a display example of a balloon help whose display amount is not less than a threshold value, according to an embodiment of the present disclosure;

FIG. 7 is a functional block diagram of a web help server according to an embodiment of the present disclosure;

FIG. 8A is a diagram illustrating a specific example of a state, a setting function, a function to be changed of a printer, and a specific example of key information generated by a print setting unit, according to an embodiment of the present disclosure;

FIG. 8B is a diagram illustrating a specific example of a web help, according to an embodiment of the present disclosure; and

FIG. 9 is a diagram illustrating a display sequence of the web help, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

For example, a conventional technique is known in which, when a user sets a printing function using a printer driver, a relationship between a given function and other function(s) that are prohibited and a reason why the user cannot set a desired function are presented, to prevent a user from making conflicting print settings.

In this conventional technique, a function that cannot be set and a reason are presented, however, specific information indicating what kind of operation should be performed in a current state in order to set a desired function, in other words, in order to release a prohibited state is not presented.

In addition, although content of a help file included in the printer driver can be freely described, the current state in the printer is not reflected in the help file. Therefore, specific information indicating what operation should be performed in the current state in order to set a desired function is not presented.

Furthermore, when changing the content of the help file, it is necessary to update the printer driver.

An information processing apparatus according to embodiments described below can present specific information relating to an operation of an image forming device.

Hereinafter, ab embodiment of the present disclosure will be described in detail with reference to drawings. Components, types, combinations, shapes, relative arrangements, and the like described in this embodiment are merely illustrative examples, not limiting the scope of the present disclosure thereto as long as there is no specific description.

Configuration of Printing System 1:

FIG. 1 is an overall configuration diagram of a printing system 1 according to an embodiment of the present disclosure.

A printing system (image forming system) 1 illustrated in FIG. 1 includes a computer apparatus (information processing apparatus) 2, a printer (image forming device) 3, and a web help server (another information processing apparatus) 4. In the printing system 1, the computer apparatus 2, the printer 3, and the web help server 4 are communicably connected via a communication line L.

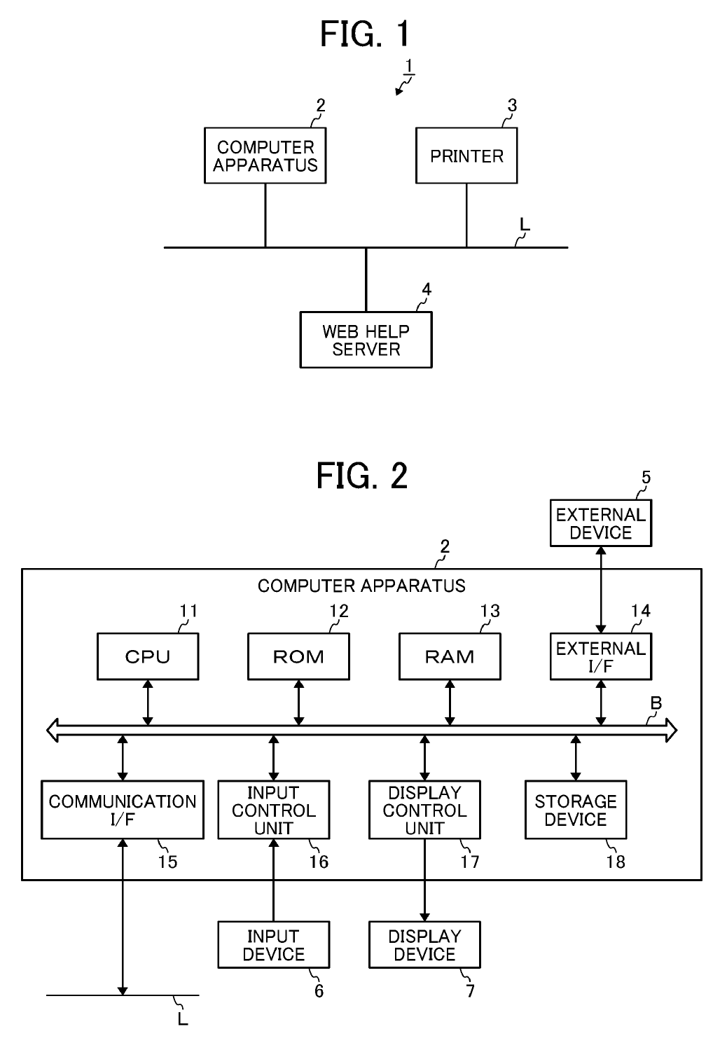

The computer apparatus 2 can perform printing with the use of the printer 3 connected via the communication line L. In addition, the computer apparatus 2 receives page information (help information, information relating to an operation of the image forming device) from the web help server 4 connected via the communication line L, and displays the received page information by the display device 7 (see FIG. 2). The computer apparatus 2 will be described later.

The printer 3 is a device that performs printing on the basis of print data transmitted from the computer apparatus 2. The printer 3 includes various functions according to specifications. For example, color printers are capable of color printing on a paper, and monochrome printers are capable of monochrome printing on a paper. In addition, various optional equipment can be mounted on the printer 3, and functions are enhanced according to the mounted optional equipment. For example, when a duplex printing unit is mounted as the optional equipment, a duplex printing function for printing on both sides of a paper can be used.

When a staple unit is mounted as the optional equipment, a staple function for binding a plurality of printed papers with a staple can be used. When a folder unit is mounted as the optional equipment, a fold function for folding the printed papers can be used.

As a printing method of the printer 3, various printing methods including an inkjet method and an electrophotography method are used. In this embodiment, while the printer 3 is described as an example of an image forming device, the image forming device is not limited to the printer 3. The image forming device includes various devices having a printing function such as a facsimile device, a copying machine, and a multifunction peripheral in addition to the printer 3.

The communication line L is an information communication network including the Internet and a local area network. The communication line can be either wired or wireless network.

Computer Apparatus 2:

FIG. 2 is a hardware configuration diagram of the computer apparatus 2 included in the printing system 1 according to an embodiment of the present disclosure.

As illustrated in FIG. 2, the computer apparatus 2 has a same configuration as a configuration of a general information processing terminal. That is, the computer apparatus 2 according to this embodiment includes a Central Processing Unit (CPU) 11, a Read Only Memory (ROM) 12, a Random Access Memory (RAM) 13, an external Interface (I/F) 14, a communication I/F 15, an input control unit 16, a display control unit 17, and a storage device 18, and each of these units is connected so as to be capable of transmitting/receiving information via the bus B.

The CPU 11 is a processor that controls entire operation of the computer apparatus 2. The ROM 12 is a read-only non-volatile storage medium, and stores a computer program such as firmware (hereinafter referred to as a program). The RAM 13 is a volatile storage medium capable of high-speed reading and writing of information, and is used as a work area when the CPU 11 processes information.

The external I/F 14 is an interface with an external device 5. The external device 5 is, for example, a device that writes information to the storage medium or reads information from the storage medium. The storage medium is, for example, a flexible disk, a flash memory, an optical disk, and a hard disk drive. The CPU 11 can read and write information to and from the storage medium via the external IF 14.

The communication I/F 15 is an interface for connecting to the communication line L. The communication I/F 15 is merely required to be able to connect to the communication line L, and for example, a wired Local Area Network (LAN) compatible with 10Base-T, 100Base-TX, and 1000Base-T and an interface of a wireless LAN compatible with 802.11a/b/g/n are used.

An input device 6 is connected to the input control unit 16. The input device 6 is, for example, a keyboard or a mouse, and outputs an operation signal corresponding to an input operation by a user. The input control unit 16 receives an input signal output from the input device 6.

A display device 7 is connected to the display control unit 17. The display device 7 is a device for displaying various kinds of images, and is a liquid crystal display, for example. The CPU 11 accepts print setting (setting relating to image formation) input by the user via a visual user interface displayed on the display device 7, and accept an operation for requesting printing or an operation for requesting display of a help (request operation by the user). The display control unit 17 outputs to the display device 7 a display signal corresponding to an image to be displayed on the display device 7.

The storage device 18 is a non-volatile storage medium capable of reading and writing information of a hard disk drive device or the like and stores various types of computer programs such as an operating system (hereinafter referred to as an OS), an application program (hereinafter referred to as an application), and a printer driver. These computer programs are provided by being recorded in a storage medium, or distributed by being downloaded from a software distribution server via the communication line L.

The OS in this embodiment is, for example, Windows (registered trademark, hereinafter the same applies) of Microsoft (registered trademark, hereinafter the same applies). In addition, functions implemented by the various programs stored in the storage device 18 will be described later.

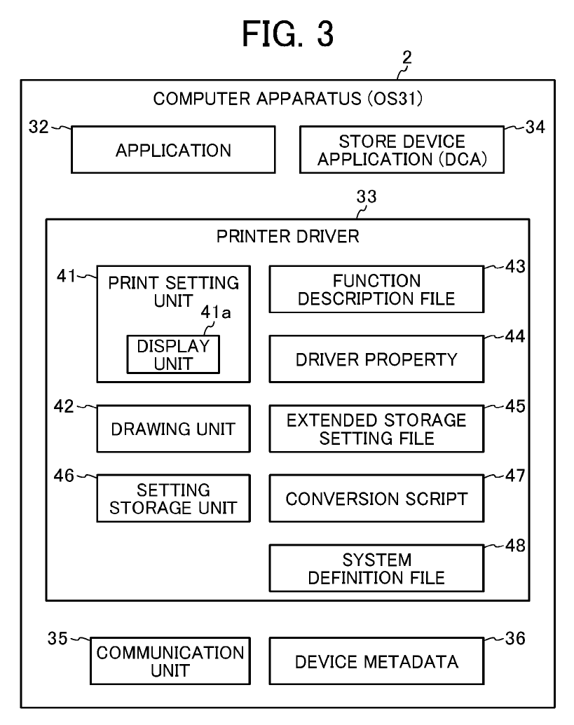

FIG. 3 is a functional block diagram of the computer apparatus 2 according to an embodiment of the present disclosure. The functional block diagram of FIG. 3 is achieved, for example, by reading the various computer programs stored in the storage device 18 by the CPU 11 of the computer apparatus 2, loading the programs on the RAM 13, and executing the programs. Some or all of the units described in the functional blocks in FIG. 3 may be implemented by a computer program or may be constructed by a hardware circuit.

In the computer apparatus 2, an OS 31 operates, and an application 32, a printer driver 33, a store device application 34, and a communication unit 35 operate on the OS 31. Further, a file called Device Metadata 36 is stored.

The application 32 is, for example, a word processing software, a spreadsheet software, a browser (web browser), and created content and display content can be printed by the printer 3. The printer driver 33 is driver software for controlling the printer 3 connected to the computer apparatus 2, and is, for example, a printer driver of V4 (Windows Version 4). The store device application 34 is a Device Companion Application (DCA) and is a type of Windows store application. The store device application 34 operates in cooperation with the printer driver 33 and causes the display device 7 to display a print setting screen unique to a printer vendor. The store device application 34 is uploaded by the printer vendor to a Windows store and distributed via the Windows store. The communication unit 35 controls communication performed via the communication line L. Therefore, communication with the printer 3 and communication with the web help server 4 are controlled via the communication unit 35.

The Device Metadata 36 is a file that holds meta information such as a type and explanation of a device. The Device Metadata 36 includes a unique name of an application and list information of a plug and play ID (PnP_ID) of the printer 3, thereby associating the printer 3 and the store device application 34 (DCA) with each other. When the printer 3 having the PnP_ID is connected to the computer apparatus 2, the OS 31 generates a logical printer in association with the printer driver 33 corresponding to the PnP_ID. The logical printer is a virtual printer set between a network and a physical printer. The Device Metadata 36 is uploaded by a vendor to a server managed by Microsoft Corporation called a Device Metadata store. Therefore, the Device Metadata 36 is distributed from the Device Metadata store.

Printer Driver 33:

Next, an example of the printer driver 33 will be described. As illustrated in FIG. 3, the printer driver 33 includes a print setting unit 41, a drawing unit 42, a function description file 43, a driver property 44, an extended storage setting file 45, a setting storage unit 46, a conversion script 47, and a system definition file 48.

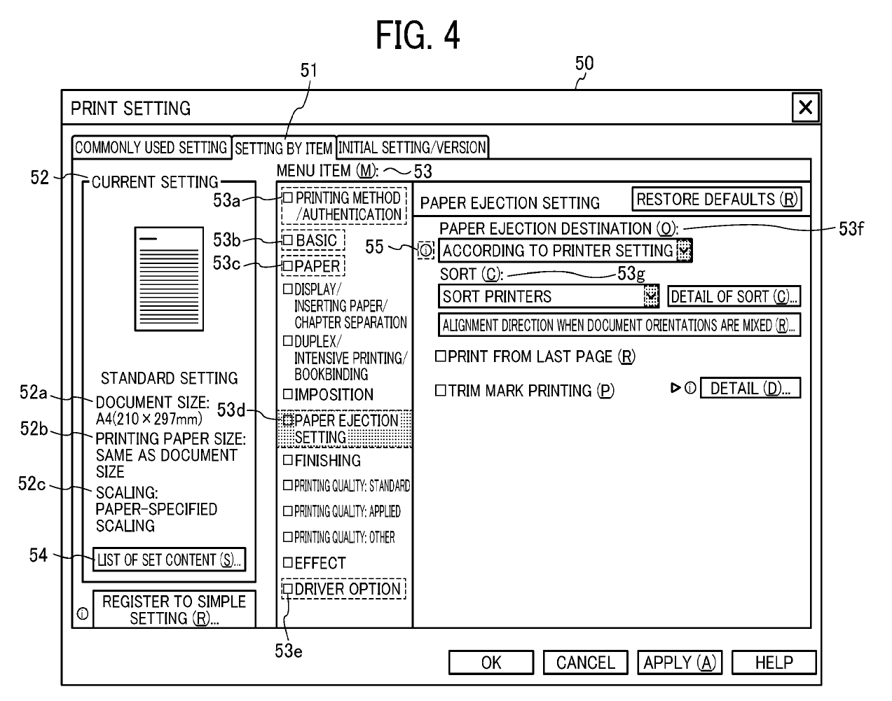

The print setting unit 41 is a module for managing print settings used for printing, such as the number of copies, duplex printing, combine printing, binding, and reduce/enlarge. The print setting unit 41 includes a display unit 41a that provides a setting UI (User Interface, see FIG. 4) 50 for displaying print settings to the user and accepting changes in the print settings from the user. The drawing unit 42 is a module that accepts image data to be printed and performs a drawing process in accordance with the print settings. The drawing unit 42 generates a print command that can be interpreted by the printer 3.

The function description file 43 is a setting file in which basic print setting items are described. For example, in the function description file 43, print setting items of the OS 31 standard and print setting items for which a value from among predetermined options is determined are described. In the function description file 43, a function of the printer 3 and a condition for using the function are set for each of a plurality of functions.

The driver property 44 is a file such that a layout setting (a tab structure, a type of UI, an order of arrangement, etc.) of the setting UI 50 displayed by the display unit 41a of the print setting unit 41 is described, and prohibition conditions and input restrictions between print setting items such as that cannot be described in the function description file 43.

In the extended storage setting file 45, data specifying an identification name and a data size of the data of print setting items such as that cannot be described in the function description file 43. The extended storage setting file 45 is stored in a storage area managed by the printer driver 33.

The setting storage unit 46 is a storage device for storing various kinds of setting information related to the function of the printer 3.

The conversion script 47 acquires the data described in the extended storage setting file 45 from the storage area, converts the data into a print ticket, and returns the ticket. In addition, the conversion script 47 receives the print ticket and stores the ticket in the storage area.

In the system definition file 48, settings related to system setting and installation of the printer driver 33 are described. In addition, the system definition file 48 holds a list of PnP_ID of a corresponding printer 3.

Display Example of Setting UI 50:

FIG. 4 is a diagram illustrating a display example of the setting UI (setting screen) 50 used for print setting (setting relating to image formation). For example, when the print setting of the printer 3 is selected from the application 32 or the print setting of the printer 3 is selected from various settings of the OS 31, the display unit 41a (first display unit) of the print setting unit 41 displays the setting UI 50 on the display device 7. In other words, when the user selects the print setting of the printer 3, the setting UI 50 is displayed on a screen of the display device 7 by the display unit 41a of the print setting unit 41.

In the setting UI 50 illustrated in FIG. 4, a setting by item tab 51 is selected. When the setting by item tab 51 is selected, a current setting 52 is displayed on a left side portion of the screen and a menu item 53 is displayed on the right side of the current setting 52.

In the current setting 52, current setting content of a document size 52a, a printing paper size 52b, and a scaling 52c are displayed. In addition, a list of set content button 54 is displayed below the scaling 52c. When the list of set content button 54 is pressed with a mouse cursor or the like (in the following description, simply described as “press a button”), the content of the current setting is displayed in a list.

In the menu item 53, a plurality of items such as a printing method/authentication 53a, basic 53b, paper 53c, . . . , paper ejection setting 53d, . . . , a driver option 53e are displayed in a state of being arranged in a vertical direction. In the display example of FIG. 4, the paper ejection setting 53d is selected, and the paper ejection destination 53f, a sort 53g, and the like are displayed as small items. In this display example, the paper ejection destination 53f is “according to the settings of the printer 3”.

On the left side of the paper ejection destination 53f, a caution button 55 is displayed. The caution button 55 is displayed in a case where there is setting content that cannot be specified by a prohibition or the like (a state where a request operation by a user can be accepted). The caution button 55 of this embodiment has a form enclosing i in Roman letters with a circle, and when the user presses the caution button 55, page information (help information) received from the web help server 4 is displayed.

Prohibition of Printer 3:

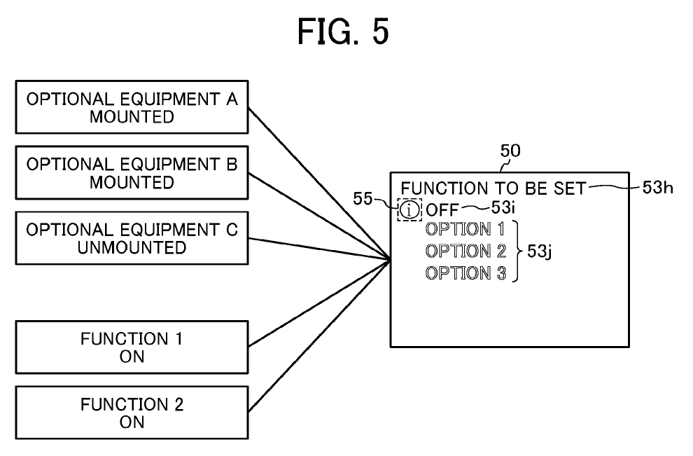

Next, a prohibition of the printer 3 will be described. FIG. 5 is a conceptual diagram illustrating an example of a state, a setting function, and a function to be changed of the printer 3.

The example illustrated in FIG. 5 indicates a state in which optional equipment A and optional equipment B are mounted on the printer 3 but optional equipment C is not mounted, and a function 1 and a function 2 are both on. Mounting information of the optional equipment is acquired by a setting program of the OS 31 at a time of generating a logical printer and held in the storage device 18 and the RAM 13 together with model information indicating a model name of the printer 3. The printer driver 33 acquires the mounting information held by the OS 31 and setting information (setting information related to a function) stored in the setting storage unit 46. In addition, the printer driver 33 acquires a prohibition condition described in the function description file 43 and the driver property 44.

The mounting information may be acquired by other methods. For example, the mounting information may be directly acquired from the printer 3 when necessary.

In the above state, a function desired to be set is prohibited on the basis of the optional equipment A, B, and C and the functions 1 and 2 and cannot be set. Accordingly, in the setting UI 50, a character 53i of “OFF” indicating that the function cannot be set is displayed, and an option 53j of the function desired to be set is displayed in a mode (for example, a gray character) indicating that the function cannot be set.

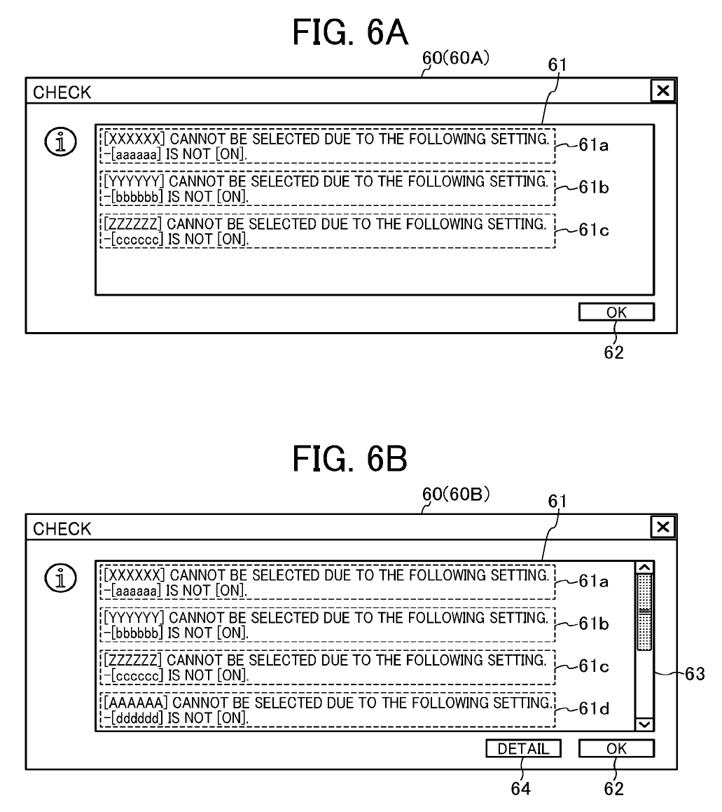

The caution button 55 is displayed on a left side of the “OFF” character 53i. By the display of the caution button 55, the user recognizes that there is page information. When the caution button 55 is pressed, the display unit 41a of the print setting unit 41 displays a balloon help 60 (see FIG. 6) on the basis of the mounting information of the optional equipment and the prohibition condition.

Balloon Help 60:

FIG. 6A is a diagram illustrating a display example of a balloon help 60 (60A) whose display amount is less than a threshold value. FIG. 6B is a diagram illustrating a display example of a balloon help 60 (60B) whose display amount is not less than a threshold value.

As illustrated in FIG. 6A, within a display frame 61 of the balloon help 60A, a sentence indicating that the function cannot be selected and other functions causing the prohibition are listed. An OK button 62 is displayed at a right end below the display frame 61. The OK button 62 is pressed when closing the balloon help 60.

In the example of FIG. 6A, a descriptive text 61a indicating that a function “XXXXXX” cannot be selected and that an item “aaaaaa” is not “ON” as a reason why the function cannot be selected is displayed. Similarly, a descriptive text 61b indicating that a function “YYYYYY” cannot be selected and that an item “bbbbbb” is not “ON” as a reason why the function cannot be selected, and a descriptive text 61c indicating that a function “ZZZZZZ” cannot be selected and that an item “cccccc” is not “ON” as a reason why the function cannot be selected are also displayed.

A reason why the descriptive texts 61a to 61c of the balloon help 60 become an enumeration of combinations of a “function” and a “reason why the function cannot be selected” is that there are a plurality of prohibition conditions. In the function description file 43 and the extended storage setting file 45, the function and the reason why the function cannot be selected are described for a plurality of prohibition conditions, and thus a file capacity increases in proportion to the number of prohibition conditions. Therefore, in order to suppress the increase in the file capacity, it is necessary to describe a combination of the function and the reason why the function cannot be selected to shorten a sentence. As a result, even if the user reads the descriptive texts 61a to 61c of the balloon help 60, the user hardly understands what kind of operation should be performed in a current state in order to set a desired function.

In particular, as illustrated in FIG. 6B, when there are a plurality of descriptive texts 61a to 61d of the balloon help 60 (for example, when scrolling is necessary to display all descriptive texts 61a to 61d), it becomes more difficult for the user to understand the operation for setting the desired function.

In order to provide specific information such as an operation to be performed in the current state, the computer apparatus 2 receives page information (information relating to an operation for canceling a prohibition setting of the printer 3) from the web help server 4, and displays on the display device 7 the web help based on the page information. At a lower right of the balloon help 60 in FIG. 6B, a detail button 64 and an OK button 62 are displayed side by side. The detail button 64 is pressed to display the web help. In this embodiment, the detail button 64 is displayed when the web help can be displayed.

Web Help Server 4:

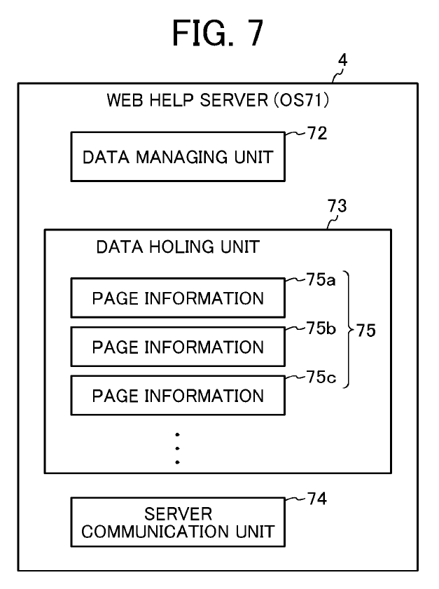

FIG. 7 is a functional block diagram of a web help server 4 according to an embodiment of the present disclosure. Similarly to the aforementioned computer apparatus 2, the web help server 4 has a same configuration as a configuration of a general information processing terminal. For this reason, a description of a hardware configuration of the web help server 4 will be omitted. The functional block diagram of FIG. 7 is achieved, for example, by reading various computer programs stored in the storage device of the web help server 4 by the CPU of the web help server 4, loading the programs on a RAM, and executing the programs. Some or all of the units described in the functional blocks in FIG. 7 may be implemented by software (computer program) or may be constructed by a hardware circuit.

In the web help server 4, an OS 71 operates, and a data managing unit 72, a data holding unit 73, and a server communication unit 74 operate on the OS 71. The data managing unit 72 manages page information 75 in the web help server 4. The data holding unit 73 holds the page information 75 in which the web help is described. A plurality of pieces of content corresponding to a state of the printer 3 and a type of setting function are prepared for the page information 75. In this embodiment, in order to simplify the description, page information 75a to page information 75c are illustrated in FIG. 7. The page information 75 can be edited by the printer vendor. In addition, as the page information 75, still image data and moving image data can be used in addition to text data. The server communication unit 74 controls communication performed via the communication line L. Therefore, the communication with the computer apparatus 2 is controlled via the server communication unit 74.

For example, the data managing unit 72 acquires the state of the printer 3 and the information of the setting function on the basis of key information (described later) received from the computer apparatus 2, and acquires from the data holding unit 73 the page information 75 corresponding to the acquired information. The data managing unit 72 transmits the acquired page information 75 to the server communication unit 74. The server communication unit 74 receives the key information from the computer apparatus 2 and transmits to the computer apparatus 2 the page information 75 received from the data managing unit 72. The computer apparatus 2 displays the received page information 75 by a browser.

Key Information:

Next, the key information will be described. The key information is generated when the computer apparatus 2 displays the web help, and is transmitted from the computer apparatus 2 to the web help server 4. The web help server 4 specifies the page information 75 on the basis of the key information and transmits the specified page information 75 to the computer apparatus 2.

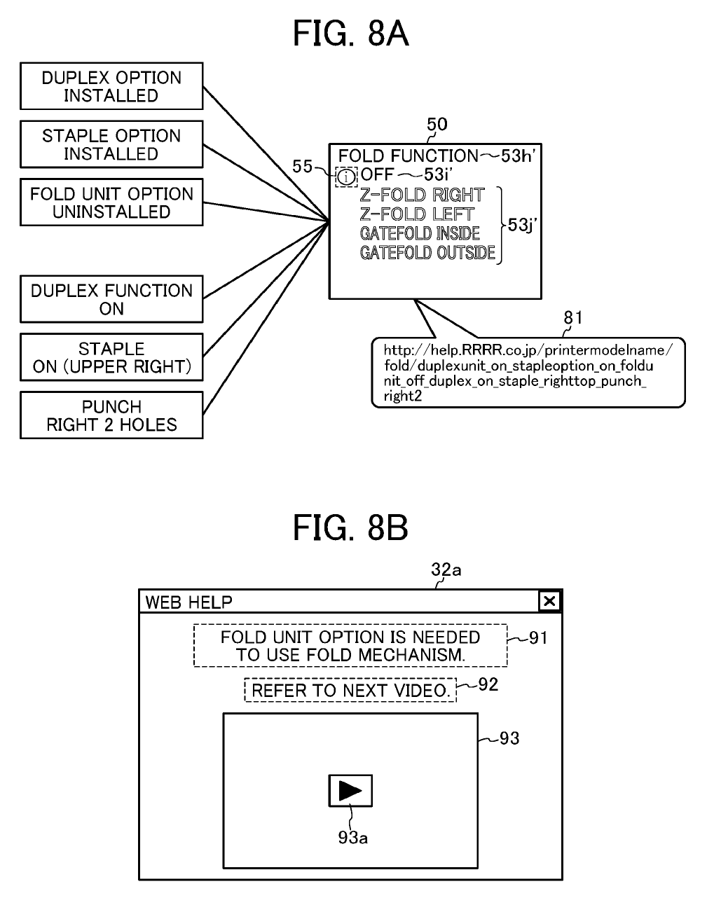

FIG. 8A is a diagram illustrating a specific example of a state, a setting function, a function to be changed of the printer 3, and a specific example of key information generated by the print setting unit 41. In the example illustrated in FIG. 8, a duplex printing unit and the stapling unit are mounted on the printer 3, and the folder unit is not mounted. Accordingly, the state of the printer 3 is such that a duplex option has been installed, a staple option has been installed, and a folder unit option has not been installed. In addition, functions of the printer 3 are such that a duplex function is on, a staple function (upper right) is on, and a punch function is set to be right two holes.

In the above state, the fold function is prohibited and cannot be set. Accordingly, in the setting UI 50, a character 53i of “OFF” indicating that the fold function cannot be set is displayed, and Z-fold right, Z-fold left, gatefold inside, and gatefold outside that are options 53j′ of the fold function are displayed in a mode (for example, a gray character) indicating that the function cannot be set.

The caution button 55 is displayed on a left side of the “OFF” character 53i′. By the display of the caution button 55, the user recognizes that there is the page information 75 (help information). When the caution button 55 is pressed, the display unit 41a of the print setting unit 41 generates key information 81 on the basis of the prohibition conditions described in the function description file 43 and the driver property 44.

The key information 81 is a Uniform Resource Identifier (URI), which is generated by the print setting unit 41 in this embodiment. The content of the key information 81 is determined on the basis of the state and setting of the printer 3.

Various kinds of information can be used for the content of the key information 81. For example, the model name (printer model) of the printer 3 connected to the computer apparatus 2, the device setting (the state of the printer 3 being connected to the computer apparatus 2), the mounting information of the optional equipment, the setting information stored in the setting storage unit 46 (setting status of other functions), the prohibition conditions described in the function description file 43 and the driver property 44, the function name specified by pressing the caution button 55, the state of the computer apparatus 2, and some or all of user/customer information can be used.

The content of the key information 81 illustrated in FIG. 8A is “http://help.RRRR.co.jp/printermodelname/fold/duplexunit_on_stapleoption_on_foldunit_off_duplex_on_staple_righttop_punchright 2”.

In the illustrated key information 81, a part “help.RRRR.co.jp” is a domain of the web help server 4, and a part “printermodelname” is the model name of the printer 3. A part “duplexunit_on_stapleoption_on_foldunit_off_option_on_staple_righttop_punch_right2” indicates that the duplex option has been installed (duplexunit_on), the staple option has been installed (stapleoption_on), the folder unit option has not been installed (foldunit_off), the duplex function is on (duplex_on), the staple function (upper right) is on (staple_righttop), and that the punch function is set to be right two holes (punch_right 2).

While the key information 81 in FIG. 8A is in a text form, the key information 81 is not limited to this structure. For example, the key information 81 may be compressed or encrypted.

Upon activation of a browser with the use of the key information 81, the computer apparatus 2 receives from the web help server 4 the page information 75 specified by the key information 81. A browser 32a displays the received page information 75.

FIG. 8B is a diagram illustrating a specific example of a web help displayed by the browser 32a. As illustrated in FIG. 8B, the web help displayed by the browser 32a includes information 91 relating to an operation for setting a desired function, message information 92 prompting the user to view a moving image, a moving image display area 93, and a play icon 93a to be pressed when playback of a moving image is started.

As described above, the content of the key information 81 reflects the state and setting of the printer 3. For this reason, it is possible to make the web help to include deeply relevant content based on the state and setting of the printer 3. An example of FIG. 8B indicates that, as the specific information 91 for using the fold function, “the folder option is needed to use the fold function”. The storage device 18 of the web help server 4 can easily secure a sufficient storage capacity, and thus the printing system 1 of this embodiment stores information relating to the folder option as moving image data. With this, a useful web help with a large amount of information can be presented to the user.

Furthermore, when the key information 81 includes the function name specified by pressing the caution button 55, it is possible to present a finely-tuned web help reflecting the user's intention. For example, suppose that a same print setting that may prohibit both punch and staple has been made. In this case, the caution button 55 is displayed corresponding to each of a punch item and a staple item. Then, when the caution button 55 on a punch item side is pressed, it is possible to display a help page (a page guiding to cancel the setting of the staple) for enabling use of the punch. Similarly, when the caution button 55 on a staple item side is pressed, a help page for enabling use of the staple (a page guiding to cancel the setting of the punch) is displayed.

In this way, in a case where a plurality of caution buttons 55 are displayed in one setting UI 50, if different key information 81 is generated for each caution button 55, the page information 75 suitable for the pressed caution button 55 (web help) can be displayed, and thus it is possible to present more appropriate information to the user.

Display Sequence of Web Help:

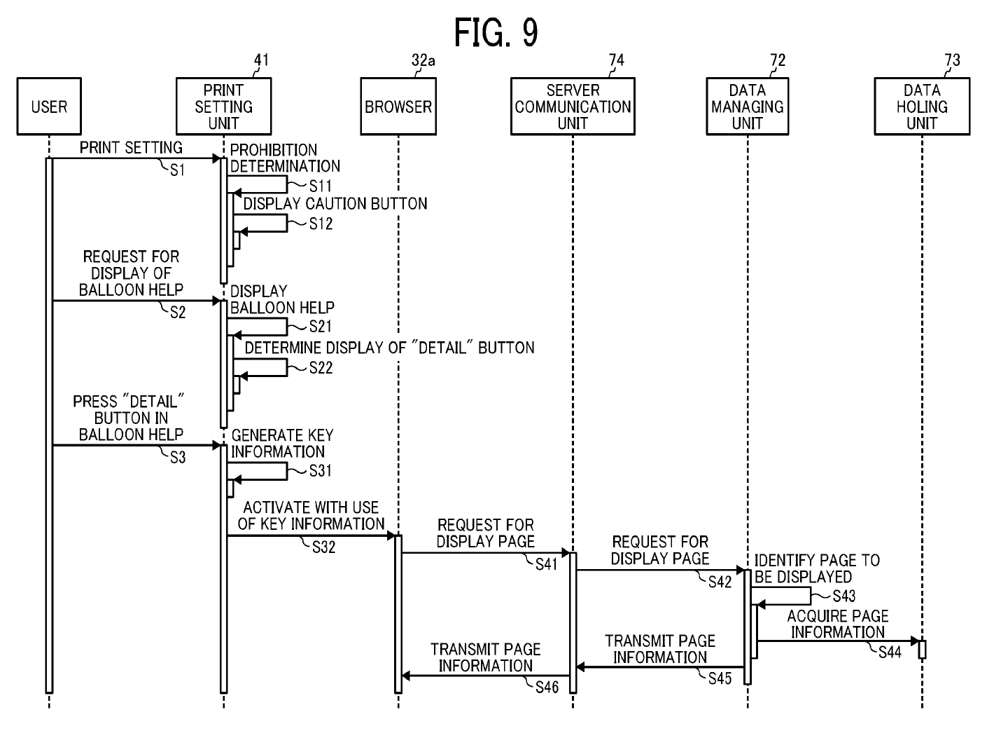

Next, a display sequence of the web help will be described. FIG. 9 is a diagram illustrating a display sequence of a web help according to an embodiment of the present disclosure.

When the user performs the print setting of the printer 3 (S1), the print setting unit 41 causes the display device 7 to display the setting UI 50 described with reference to in FIG. 4. In addition, as the print setting is performed, the print setting unit 41 makes a prohibition determination (S11). The prohibition determination is a process of determining presence or absence of a prohibition on a setting target function. The print setting unit 41 refers to the function description file 43 and the driver property 44, and the like described with reference to FIG. 3 to determine the presence or absence of a prohibition.

When it is determined that there is a prohibition by the prohibition determination (S11), the print setting unit 41 displays the caution button 55 (see FIG. 4) in the vicinity of a corresponding item in the setting UI 50 (S12). If it is determined that there is no prohibition by the prohibition determination (S11), the print setting unit 41 does not display the caution button 55.

When a request for display of the balloon help 60 (pressing of the caution button 55) is made by the user (S2), the print setting unit 41 displays the balloon help 60 (S21). As described above, the print setting unit 41 displays the balloon help 60 whose content is determined according to the mounting information of the optional equipment and the prohibition conditions. The display amount of the balloon help 60 changes according to a combination of the mounting information and the prohibition conditions. The print setting unit 41 determines whether the display amount of the balloon help 60 has exceeded a threshold value. When the display amount has exceeded the threshold value, the detail button 64 is displayed (S21). In this embodiment, for example, as described with reference to FIG. 6A, when all help content can be displayed without scrolling, it is determined that the display amount of the balloon help 60 has not exceeded the threshold value. On the other hand, as described with reference to FIG. 6B, when all the help content cannot be displayed without scrolling, it is determined that the display amount of the balloon help 60 has exceeded the threshold value, and the detail button 64 is displayed. The above criterion is an example, and the criterion can be determined as appropriate.

When the user presses the detail button 64 (requests for display of the web help) (S3), the print setting unit 41 generates the key information 81 (S31). As described with reference to FIG. 8A, the content of the key information 81 is determined on the basis of the state and setting of the printer 3. The print setting unit 41 activates the browser 32a with the use of the generated key information 81 (S32). For example, the browser 32a is activated with the key information 81 as a URL.

The browser 32a accesses the server communication unit 74 on the basis of the key information 81 and requests for the page information 75 of a display page indicated by the key information 81 (S41). In response to the request from the browser 32a, the server communication unit 74 accesses the data managing unit 72 and requests for the page information 75 of the display page (S42). On the basis of the key information 81, the data managing unit 72 identifies the display page from among display pages held by the data holding unit 73 (S43), and then acquires the page information 75 corresponding to the display page from the data holding unit 73 (S44). The data managing unit 72 transmits the acquired page information 75 to the server communication unit 74 (S45). The server communication unit 74 transmits the received page information 75 to the browser 32a (S46). The browser 32a displays the web help on the basis of the received page information 75.

In the printing system 1 according to this embodiment, when the caution button 55 is pressed in a state in which the setting UI 50 is displayed, the print setting unit 41 generates the key information 81 on the basis of the state and setting of the printer 3, and activates the browser 32a with the use of the key information 81. The browser 32a accesses the web help server 4 on the basis of the key information 81, receives the page information 75 corresponding to the key information 81 from the web help server 4, and displays the page information 75.

In this way, in the printing system 1 according to this embodiment, the web help server 4 is accessed on the basis of the key information 81, and the page information 75 corresponding to the key information 81 is received from the web help server 4 and displayed. Therefore, a degree of freedom of content regarding the page information 75 can be increased and specific information relating to the operation of the printer 3 can be presented. For example, it is possible to present to the user a procedure of an operation that is to be performed to enable a function that the user wants to set, and it is also possible to present the procedure of the operation by a still image or a moving image. In addition, since the printer vendor can update the page information 75 held in the web help server 4, it is possible to present the latest page information 75 without imposing a burden on the user.

Variations:

In the above embodiment, while the print setting unit 41 generates the key information 81 (URI) that specifies the page information 75 held in the web help server 4, and activates the browser 32a using the key information 81, the print setting unit 41 is not limited to this configuration. Information other than the key information 81 may be used as long as the page information 75 held in the web help server 4 can be specified.

In the above embodiment, while the key information 81 is generated on the basis of the print setting and a mounting state of the optional equipment, the key information 81 may be generated without using the mounting state of the optional equipment.

With regard to the page information 75 of the web help, information other than the information indicating the operation for canceling the prohibition setting of the printer 3 may be presented to the user.

An information processing apparatus (computer apparatus 2) according to a first aspect receives, from another information processing apparatus (web help server 4) connected to the information processing apparatus via a communication line (communication line L), information (page information 75 of a web help) relating to an operation of an image forming device (printer 3), and displays the information. The information processing apparatus includes: a first display unit (print setting unit 41) that displays a setting screen (setting UI 50) for receiving a setting (print setting) relating to image formation; a transmitter (communication unit 35) that transmits, to the another information processing apparatus (web help server 4), request information (key information 81) based on setting information (set content of print items) received via the setting screen, when a request operation by a user (display request of the balloon help 60) is accepted; and a second display unit (browser 32a) that receives information relating to an operation corresponding to the request information from the another information processing apparatus and displays the information.

According to the information processing apparatus of the first aspect, it is possible to enhance flexibility of content with regard to the information relating to the operation of the image forming device, and to present specific information relating to the operation of the image forming device.

In the information processing apparatus according to a second aspect, the setting information includes a setting value of each of a plurality of setting items (set content of a plurality of print items).

According to the information processing apparatus of the second aspect, it is possible to provide information having specific content determined in accordance with the setting values of the plurality of setting items.

In the information processing apparatus according to a third aspect, in response to receiving one request operation (when one “caution button 55” is pressed) in a state in which a plurality of request operations are acceptable (a state in which a plurality of “caution buttons 55” are displayed on a UI), the transmitter transmits request information based on the setting information corresponding to the one request operation.

According to the information processing apparatus of the third aspect, it is possible to provide information having specific content determined in accordance with the setting information corresponding to the one request operation.

In the information processing apparatus according to a fourth aspect includes a generator (print setting unit 41) that generates the request information based on the setting information.

According to the information processing apparatus of the fourth aspect, the generator and the transmitter are configured separately, and thus it is possible to increase flexibility of processing by performing other processing between generation of the request information and transmission of the request information.

In the information processing apparatus according to a fifth aspect, the generator generates a request state on the basis of the setting information and state information indicating a state of the image forming device (the model information of the printer 3, the information of the optional equipment).

According to the information processing apparatus of the fifth aspect, it is possible to provide information having specific content determined in accordance with the setting information and the state information.

In the information processing apparatus according to a sixth aspect, the state information includes the model information relating to the image forming device and information relating to optional equipment mounted on the image forming device.

According to the information processing apparatus according to the sixth aspect, it is possible to provide information having specific content determined in accordance with information relating to the model information and the optional equipment.

In the information processing apparatus according to a seventh aspect, the information relating to the operation is information indicating an operation for canceling a prohibition setting of the image forming device.

According to the information processing apparatus according to the seventh aspect, it is possible to provide specific information indicating the operation for canceling the prohibition setting of the image forming device.

According to an eighth embodiment, there is provided an information processing method performed by an information processing apparatus that receives and displays information relating to an operation of an image forming device from another information processing apparatus connected to the information processing apparatus via a communication line. The method includes: displaying a setting screen for receiving a setting relating to image formation; in response to receiving a request operation by a user, transmitting request information based on setting information received via the setting screen to the another information processing apparatus; and receiving and displaying information relating to the operation corresponding to the request information from the another information processing apparatus.

According to the information processing method of the eighth aspect, it is possible to enhance flexibility of content regarding the information relating to the operation of the image forming device, and to provide specific information relating to the operation of the image forming device.

According to a ninth aspect, there is provided a program causing a computer to execute the information processing method according to the eighth aspect.

According to the program of the ninth aspect, the same or substantially the same effects as those of the eighth aspect are provided.

According to a tenth aspect, there is provided an image forming system including the information processing apparatus according to any one of the first to seventh aspects and the image forming device.

According to the image forming system of the tenth aspect, the same or substantially the same effects as those of the first to seventh aspects are provided.

Any one of the above-described operations may be performed in various other ways, for example, in an order different from the one described above.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing apparatus for receiving information relating to an operation of an image forming device from another information processing apparatus connected to the information processing apparatus via a communication line and displaying the information received from the another information processing apparatus, the information processing apparatus comprising:
circuitry configured to:
cause a display to display a setting screen via which a setting relating to image formation is accepted;
in response to accepting a request operation by a user, transmit request information based on setting information accepted via the setting screen to the another information processing apparatus; and
cause a browser to receive the information relating to the operation corresponding to the request information from the another information processing apparatus and display the received information relating to the operation.

2. The information processing apparatus according to claim 1, wherein
the setting information includes a setting value of each of a plurality of setting items.

3. The information processing apparatus according to claim 1, wherein
in response to accepting one request operation in a state in which a plurality of request operations are acceptable, the circuitry transmits the request information based on the setting information corresponding to the one request operation.

4. The information processing apparatus according to claim 1, wherein
the circuitry is further configured to generate the request information based on the setting information.

5. The information processing apparatus according to claim 4, wherein
the circuitry is further configured to generate the request information based on the setting information and state information indicating a state of the image forming device.

6. The information processing apparatus according to claim 5, wherein
the state information includes model information relating to the image forming device and information relating to optional equipment mounted on the image forming device.

7. The information processing apparatus according to claim 1, wherein
the information relating to the operation is information indicating an operation for canceling a prohibition setting of the image forming device.

8. An information processing method, performed by an information processing apparatus that receives information relating to an operation of an image forming device from another information processing apparatus connected to the information processing apparatus via a communication line and displays the information received from the another information processing apparatus, the information processing method comprising:
displaying a setting screen via which a setting relating to image formation is accepted;
in response to accepting a request operation by a user, transmitting request information based on setting information accepted via the setting screen to the another information processing apparatus;
receiving the information relating to the operation corresponding to the request information from the another information processing apparatus; and
displaying the information relating to the operation received from the another information processing apparatus.

9. The information processing method according to claim 8, wherein
the setting information includes a setting value of each of a plurality of setting items.

10. The information processing method according to claim 8, wherein
in response to accepting one request operation in a state in which a plurality of request operations are acceptable, the transmitting transmits the request information based on the setting information corresponding to the one request operation.

11. The information processing method according to claim 8, further comprising generating the request information based on the setting information.

12. The information processing method according to claim 11, wherein
the generating generates the request information based on the setting information and state information indicating a state of the image forming device.

13. The information processing method according to claim 12, wherein
the state information includes model information relating to the image forming device and information relating to optional equipment mounted on the image forming device.

14. The information processing method according to claim 8, wherein
the information relating to the operation is information indicating an operation for canceling a prohibition setting of the image forming device.

15. A non-transitory computer-readable storage medium storing a program causing an information processing apparatus for receiving information relating to an operation of an image forming device from another information processing apparatus connected to the information processing apparatus via a communication line and displaying the information received from the another information processing apparatus to execute an information processing method, the information processing method comprising:
displaying a setting screen via which a setting relating to image formation is accepted;
in response to accepting a request operation by a user, transmitting request information based on setting information accepted via the setting screen to the another information processing apparatus;
receiving the information relating to the operation corresponding to the request information from the another information processing apparatus; and
displaying the information relating to the operation received from the another information processing apparatus.

16. The non-transitory computer-readable storage medium according to claim 15, wherein
the setting information includes a setting value of each of a plurality of setting items.

17. The non-transitory computer-readable storage medium according to claim 15, wherein
in response to accepting one request operation in a state in which a plurality of request operations are acceptable, the transmitting transmits the request information based on the setting information corresponding to the one request operation.

18. The non-transitory computer-readable storage medium according to claim 15, wherein the method further comprising generating the request information based on the setting information.

19. The non-transitory computer-readable storage medium according to claim 18, wherein
the generating generates the request information based on the setting information and state information indicating a state of the image forming device.

20. The non-transitory computer-readable storage medium according to claim 19, wherein
the state information includes model information relating to the image forming device and information relating to optional equipment mounted on the image forming device.
